(19) United States
(12) Patent Application Publication
(10) Pub. No.: US 2008/0091744 A1
(43) Pub. Date: Apr. 17, 2008

(54) Method and apparatus for indexing and searching data in a storage system

(76) Inventors: Hidehisa Shitomi, Mountain View, CA (US); Yuichi Yagawa, Kanagawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/545,561

(22) Filed: Oct. 11, 2006

(51) Int. Cl. G06F 17/30

(52) U.S. Cl. 707/204

(57) ABSTRACT

A storage system includes a first volume for storing data received from a computer. A second volume stores a copy of the first volume, and a journal volume stores write data written to the first volume as journal entries. Index tables of data stored to the first volume are created for one or more points in time after the creation of the second volume. The index tables can be searched for file information, such as to enable location of a particular instance of a file stored to the first volume at a particular point in time. File information is located by the search, and the particular instance the file may be retrieved from a first virtual volume created by applying entries in the journal volume to the second volume up to a specified second point in time. The instance of the file may be recovered to the first volume.

### BACKGROUND OF THE INVENTION

1. Field of the Invention

The present invention relates generally to storage systems.

2. Description of Related Art

The ability to index and search data is necessary in various types of computer systems, including storage systems. For example, the Google® search engine is one of the best-known Internet search engines used for searching for information on the World Wide Web. Such Internet search engines are able to provide a coarse-grained history of file modifications. However, because these histories are collected at particular points in time which usually have large time intervals, such coarse-grained histories are not always useful for obtaining specific desired information.

To create a searchable history, the software uses programs called spiders to collect data from websites by crawling through each web page and any links from the web page. The spiders will typically start with a heavily used website by indexing all words on all the pages of the website and following every link found within the site. This enables the spider to spread out over the more popular pages on the web to collect and index data from each web page. The spiders typically build a list of every significant word on a page and note where the words are found. The search engine may include a weighting system for weighting words for each webpage according to a perceived significance for that webpage to enable the webpage to be ranked higher in subsequent searching so as to increase relevance of the search results. The created index may be encoded and stored so as to be able to be searched by users using a query of one or more words in combination with Boolean operators. However, Internet search engines are limited in their ability to be applied to other uses.

CDP (Continuous Data Protection) is a technique in which a storage system continuously captures or tracks every modification to the data stored in the storage system. Under CDP technology, the data is backed up whenever any change is made to the data. In effect, CDP creates a continuous journal of complete storage snapshots, i.e., one storage snapshot for every instant in time that a data modification occurs. CDP is different from traditional data backup in that it is not necessary for a user to specify a point in time at which the user would like to recover the data until the user is actually ready to perform a restore operation. Traditional data backup systems, on the other hand, are only able to restore data to certain discrete points in time at which backups were made, such as one hour, one day, one week, etc. However, with CDP, there are no backup schedules. If the storage system becomes contaminated with a virus, or if a file in the system is corrupted or accidentally deleted, and the problem is not discovered until some time later, a user is still able to recover the most recent uncorrupted version of the file. Further, a CDP system set up on a disk array storage system enables data recovery in a matter of seconds, which is considerably less time than is possible with tape backups or archives.

According to CDP technology, the storage system, backup software in the host computers, or other hardware or software captures write I/O operations from the host computer file systems, and records all of the write I/Os as a journal in a journal volume. Also, when CDP is started, the system initially preserves a baseline copy of the production data primary volume (i.e., the volume for which the users want to have the data backed up), which is the initial image of the primary volume when CDP is started. When recovering data, by applying the journal against the initial baseline image of the volume, CDP enables recovery of data at any point at which write operations were made to the primary volume. However, with CDP it is not always easy for a user to find an appropriate or desired point for recovery of data. Because CDP continuously copies data into journals, the number of journal entries can become very large and difficult to manage.

US Pat. Appl. Pubs. 20040268067, filed Jun. 26, 2003, 20050015416, filed Jul. 16, 2003, and 20050022213, filed Jul. 25, 2003, all to Kenji Yamagami, the disclosures of which are incorporated herein by reference, discuss various CDP techniques. US Pat. Appl. Pub. 20060074964, to Pallapotu, filed Sep. 30, 2004, the disclosure of which is incorporated herein by reference, discloses a method of index creation during data backup in a computer system.

### BRIEF SUMMARY OF THE INVENTION

A method for searching data at any point in time is provided. Point in time index tables may be created at any time, and do not need to store the entire data at each data collection time, since the data can be retrieved from a journal volume when the data is needed. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware configuration in which the method and apparatus of the invention may be applied.

FIG. 2 illustrates an exemplary software configuration of one embodiment of the invention.

FIG. 3 illustrates a conceptual diagram of CDP operations conducted by the CDP module.

FIG. 4 illustrates an exemplary conceptual diagram of the indexing process when the administrator requests the creation of index tables at some point in time.

FIG. 5 illustrates examples of index tables created according to the invention.

FIG. 6 illustrates an exemplary process flow of the indexing module.

FIG. 7 illustrates an exemplary conceptual diagram of the indexing process invoked at some event.

FIG. 8 illustrates an exemplary conceptual diagram of the search and recovery process.

FIGS. 9-1A through 9-1C illustrate examples of the GUI of the invention at a starting point.

FIG. 9-2 illustrates how the administrator is able to pick some of the file names and times in the search result.

FIG. 9-3 illustrates how the GUI can display a selected file content.

FIG. 9-4 illustrates how the administrator can input the recover destination using the GUI.

FIG. 10-1 illustrates a control flow of the search module based on the GUI.

FIG. 10-2 illustrates a control flow of the finalize operations of the search module.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any manner.

The invention is directed to a search system and method of indexing and searching data. In some embodiments, the invention may be implemented with CDP technology to enable data to be recovered at any point in time. For example, it is not always easy to find an appropriate recovery point when using CDP technology, because CDP continuously copies I/O operations into a journal, and there can be a large number of operations in the journal. The invention includes a search system, and is able to employ an indexing and search technology with CDP, which then enables easier location of an appropriate recovery point. Additionally, the invention enables the creation of index information of the data at any point in time, such as in the form of index tables, and utilizes the index tables for searching a recovery point. Further, an administrator is able to track the modifications to the data over the various generations as the data is changed.

The embodiments next described illustrate how the invention may be implemented with CDP functionality in a NAS (network attached storage) head. However, a storage controller or other hardware appliances may also be used to implement the CDP functionality and other features of the invention. Accordingly, the invention is not limited to a particular hardware arrangement or CDP implementation method. For example, the CDP journal or other data may reside in a host or separate appliance. Further, while the invention is described in a NAS system and a file-based storage environment, it will be apparent to those skilled in the art that the invention may be equally well applied in a block-based storage environment, or in a heterogeneous environment that utilizes NAS gateway along with block-based storage. Also, while the invention is implemented with CDP technology in some of the embodiments, the invention is related to searching and indexing of data in other environments as well, such as any environment that includes the equivalent of a journal and a baseline volume, or similar arrangement.

System Configurations

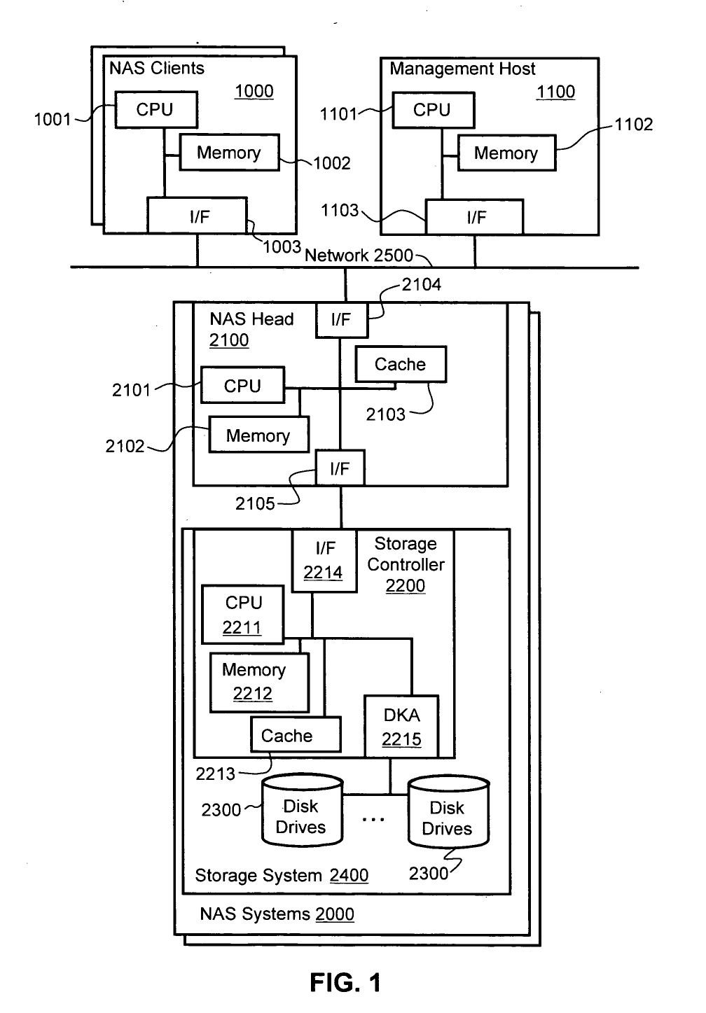

FIG. 1 illustrates an example of a hardware configuration in which the method and apparatus of the invention may be applied. The system includes one or more NAS clients 1000, a management host 1100, and one or more NAS systems 2000 able to communicate via a network 2500. The typical media of network 2500 may be Ethernet (TCP/IP) protocol, however, the invention is not limited to any particular network type or protocol, and thus, Fibre Channel (FC), WiFi, or other protocol types may be used with particular hardware implementations of the invention.

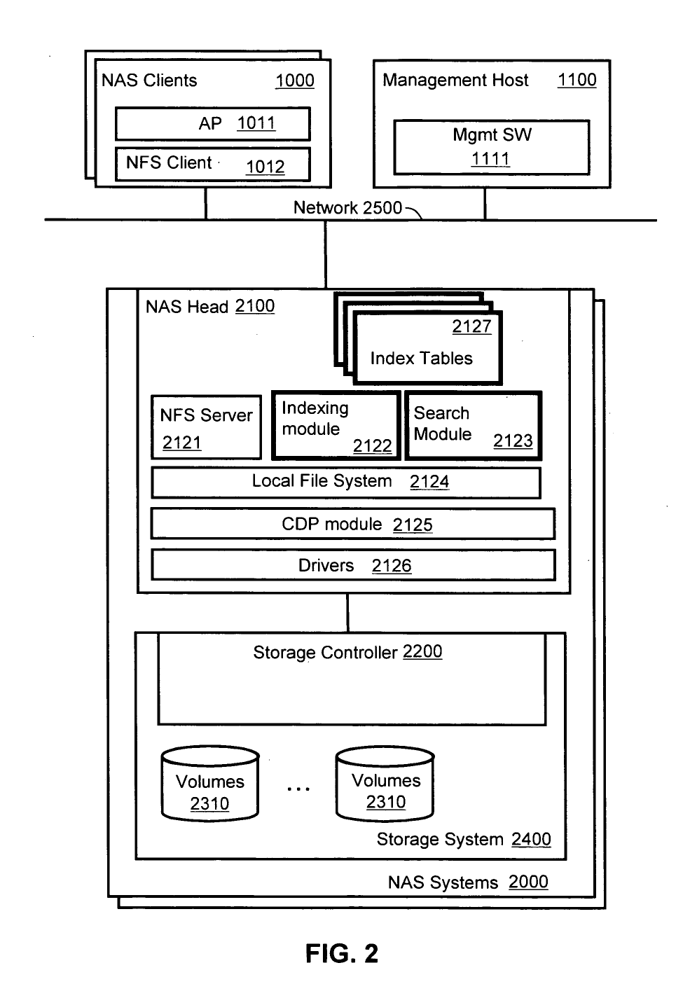

Each NAS client 1000 includes a CPU 1001 and a memory 1002 for executing one or more applications and NFS (Network File System) client software (as discussed below with respect to FIG. 2). NAS client 1000 includes a network interface (I/F) 1003, such as a NIC (network interface card), or the like, which enables NAS client 1000 to communicate via network 2500.

Management host 1100 includes a management CPU 1101 and a memory 1102 for executing management software (as discussed below with respect to FIG. 2). Management host 1100 further includes a network I/F 1103, which may be a NIC or the like, which enables management host 1100 to communicate via network 2500.

NAS system 2000 includes two main parts: a storage system 2400 and a NAS head 2100. The storage system 2400 includes a storage controller 2200 and storage media 2300. Storage media 2300 are preferably a plurality of hard disk drives, but in other embodiments may be solid state memory, optical storage, or other non-volatile rewriteable storage media. NAS head 2100 and storage system 2400 may be in communication via an interface 2105 in NAS head 2100 and an interface 2214 in storage controller 2200. In some hardware embodiments, NAS head 2100 and storage system 2400 may exist in a single storage unit. In such a case, the two elements are connected via a system bus, such as a PCI bus. On the other hand, the NAS head and storage controller may be physically separated at the same location or in different locations. In this case, NAS head 2100 and storage controller 2200 may be in communication via a network connection, such as via FC protocol, Ethernet protocol, or the like.

NAS head 2100 includes a CPU 2101, a memory 2102, a cache memory 2103, front-end network interface 2104, which may be a NIC, and a disk or backend network interface 2105. NAS head 2100 processes input/output (I/O) requests from NAS clients 1000, and management and configuration instructions received from management host 1100. NAS head CPU 2001 processes NFS requests or performs other operations using programs (described below) stored in the memory 2102. Cache 2103 stores NFS write data from NAS clients 1000 temporarily before the data is forwarded from NAS head 2100 to storage system 2400. Cache 2103 also stores NFS read data requested by the NAS clients 1000. Cache 2103 may be a battery backed-up non-volatile memory to avoid data loss during power outage. In another implementation, memory 2102 and cache memory 2103 are common combined memory. Front-end interface 2104 is used by NAS head 2100 to communicate via network 2500 with NAS clients 1000 and management host 1100. Ethernet is a typical example of the types of connection used. Backend interface 2105 is used by NAS head 2100 to communicate with storage system 2400 using similar protocols as discussed above.

Storage controller 2200 includes a CPU 2211, a memory 2212, a cache memory 2213, host interface 2214, and disk interface (DKA) 2215. Storage controller 2200 processes I/O requests received from the NAS Head 2100. CPU 2211 executes programs to process the I/O requests or other operations, and these programs (as discussed below) are stored in memory 2212 or disk drives 2300. Cache memory 2213 stores write data received from the NAS Head 2100 temporarily before the data is stored into disk drives 2300. Cache memory 2213 also stores read data requested by the NAS Head 2100 before it is transmitted to NAS head 2100. Cache memory 2213 may be a battery backed-up non-volatile memory to avoid data loss during a power outage. In other implementations, memory 2212 and cache memory 2213 may be a common combined memory. Host interface 2214 enables communication between controller 2200 and NAS head 2100. Ethernet and FC are typical examples of the communication connection. Alternatively, a system bus connection such as PCI can be used depending on the hardware configuration. Disk interface 2215 may be a disk adapter used to enable communication between disk drives 2300 and the storage controller 2200, and may be FC, SCSI, or the like. Disk drives 2300 process I/O requests in accordance with received disk device commands, such as SCSI commands. Further, it will be apparent that other appropriate hardware architecture can be applied to the invention, with the configuration described above being only exemplary.

FIG. 2 illustrates an example of a software configuration in which the method and apparatus of the invention may be applied. Each NAS Client 1000 is a computer that usually includes an application (AP) 1011 and a Network File System (NFS) client program 1012 that reside on NAS client 1000 in memory 1002 or other computer readable medium. Application 1011, when executed by CPU 1001, typically generates file manipulating operations and produces I/O operations to storage system 2400 via NAS head 2100. NFS client program 1012 such as NFSv2, v3, v4, or CIFS (Common Internet File System) also runs on NAS client 1000, and communicates with NFS server programs 2121 on NAS systems 2000 through network protocols such as TCP/IP, or other protocol, over network 2500, as discussed above, for transmitting the I/O operations.

Management Host 1100 includes management software 1111 that resides on management host 1100 in memory 1102 or other computer readable medium. NAS management operations such as system configurations, CDP related operations, and indexing and search commands can be issued from management software 1111.

The software configuration of each NAS System 2000 consists of two main parts: NAS Head 2100 software and Storage System 2400 software. NAS Head 2100 is the module that processes file-related operations. The programs to process NFS requests or other operations are stored in memory 2102, or other computer readable medium, and CPU 2101 executes these programs. These programs may include NFS server module 2121, a local file system 2124, a CDP module 2125, drivers 2126, an indexing module 2122, and a search module 2123. NFS server 2121 is used by NAS head 2100 in order to communicate with NFS client program 1012 on the NAS clients 1000. The local file system 2124 processes file I/O operations to the storage system 2400, and drivers of storage system 2126 translate the file I/O operations into block-level operations, and communicate with storage controller 2200, such as via SCSI commands. CDP module 2125 conducts CDP related operations such as copying file I/O operations to a journal volume. The CDP operations are described in additional detail below. Further, a number of service programs are able to run on the NAS Head 2100, such as indexing module 2122 and search module 2123. A plurality of index tables 2127 may be created by the indexing module 2122, and utilized by the search module 2123, as will be described below. The index tables 2127 can be stored in local disks of NAS head 2100 (not shown), memory 2102, or disks 2300 on the storage system 2400. Additionally, other NAS management software may run on NAS head 2100 which is not depicted in FIG. 2.

In storage system 2400, storage controller 2200 processes SCSI or other type of commands received from NAS head 2100. One or more logical volumes are allocated storage space on disk drives 2300 and managed by storage controller 2200. Typically each volume 2310 is composed from storage space on one or more of disk drives 2300, which may be arranged in a RAID or other configuration. Further, one or more file systems are created for use with volumes 2310 by local file system 2124 to facilitate file-based storage.

CDP Process

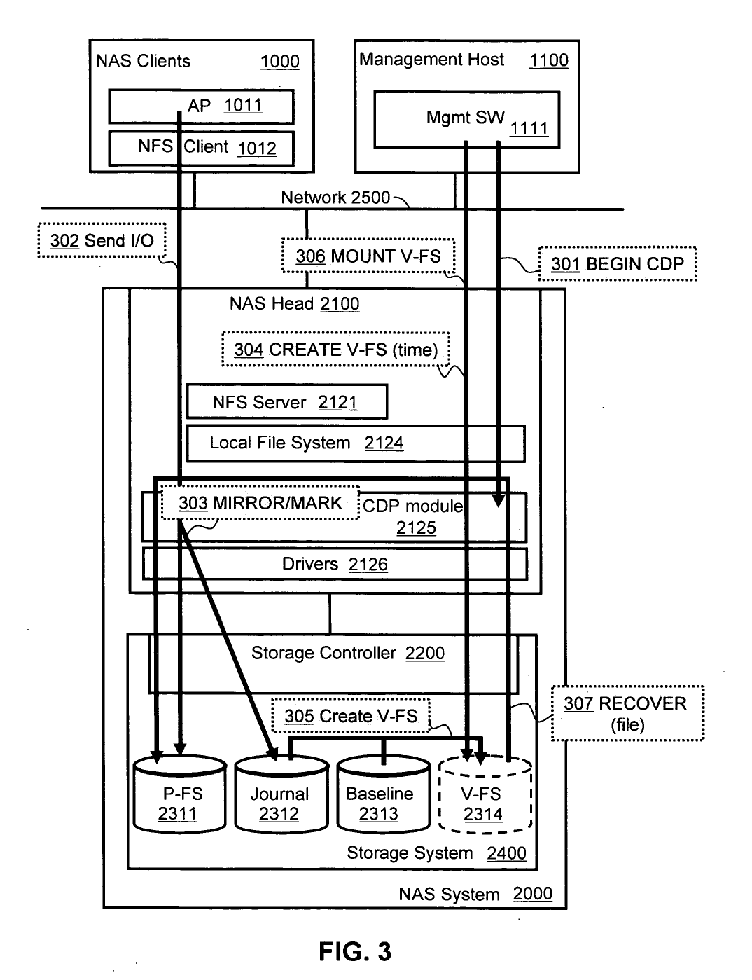

FIG. 3 illustrates a conceptual diagram that includes CDP operations conducted by CDP module 2125 in NAS head 2100. As described above, the invention is not restricted by the implementation method of CDP, and is not restricted only to CDP, but may also be used in other environments. Accordingly, CDP module 2125 can alternatively be located in the storage controller 2200 or elsewhere, and is not limited to being implemented in NAS head 2100. In the example illustrated, the volumes used include a primary volume 2311 that has a primary file system created thereon, a journal volume 2312, and a baseline volume 2313 that is an initial copy of primary volume 2311 at a first point in time when CDP operations are set up. Also, a virtual file system volume 2314, which does not need to be an actual volume, may be created during certain stages of the method of the invention, as is described below. The published patent applications to Yamagami incorporated by reference above describe additional details of CDP implementation.

At Step 301, storage management software 1111 requests that CDP module 2125 begin the CDP operations. Baseline volume 2313 and journal volume 2312 are initialized at the beginning of CDP operations. A new baseline copy can be taken at any time during the CDP operations. If baseline copies of the primary volume are taken frequently, then data can be recovered more quickly because the amount of journal data to be applied to the baseline copy is less. However, frequent baseline copy operations place a greater workload on the system due to the frequent copy operations. Accordingly, the frequency of baseline copy depends on each system's administrative policy.

At Step 302, application 1011 on NAS client 1000, which is able to access primary volume 2311 for storing and retrieving data, sends an I/O operation to NAS head 2100 directed to primary volume 2311.

At Step 303, the CDP module 2125 copies the file I/O operation, and writes the copied operations into journal volume 2312 in the storage system 2400, and includes one or more markers such as current time and sequence number. Thus, according to CDP procedure, as each write data is written to the primary volume 2311, the data is copied to the journal volume 2312, and markers applied to the data written in the journal volume aid recovery to particular write operations.

At Step 304, management software 1111 sends a request for the recovery of data at some point in time to the CDP module 2125, which requires creation of a virtual file system volume 2314.

At Step 305, CDP module 2125 utilizes both baseline copy volume 2313 and journal volume 2312 to create virtual file system volume 2314 as the point in time copy of the recovery point. This does not require actual copying of data to another volume, but instead, CDP module presents virtual file system volume 2314 as if it contained the data of baseline volume 2313 with the journal entries of journal volume 2312 applied to baseline volume 2313 up to a predetermined point in time. Thus, a virtual file system of the data may be presented by CDP module 2125 as if it actually had been created.

At Step 306, when the virtual file system volume 2314 has been created by the CDP module 2125 for the requested point in time, the virtual file system volume 2314 is mounted to the management host 1100 or other user requesting recovery as if it were a real volume.

At Step 307, administrators or users are able to recover specified data in the virtual file system to the primary file system volume 2311 through the file system operations.

Typically, at the recovery phase, the administrator would like to recover data at some point in time. The desired recovery point is usually a point in time just before a user made some erroneous operations. However, the administrator usually does not know an appropriate recovery point, and conventional CDP modules are only able to provide marker information which includes information such as I/O copying time and sequence number. Thus, it is not always easy for administrators or users to find an appropriate point in time for recovery.

Accordingly, as discussed above, the invention includes index tables and a search system to enable faster and easier data recovery. CDP technology is employed to provide a method for creating index tables at any point in time, and for searching data at any point in time by using the index tables. However, the invention is not limited to CDP applications, and may be implemented in other environments. Moreover, the invention is able to provide assistance to administrators for finding an appropriate recovery point by employing the indexing module and the search module.

Indexing Process

Indexing module 2122 is a module that creates index tables of CDP journal volume 2312 at some point in time. The time of indexing can be designated by administrators though management software 1111. In another aspect, the indexing module 2122 can be configured to create index tables at the occurrence of some event, such as at initiation of file close operations, by getting the notification from CDP module 2125. Moreover, the indexing module 2122 is able to be configured to create index tables periodically on a regular basis, such as nightly.

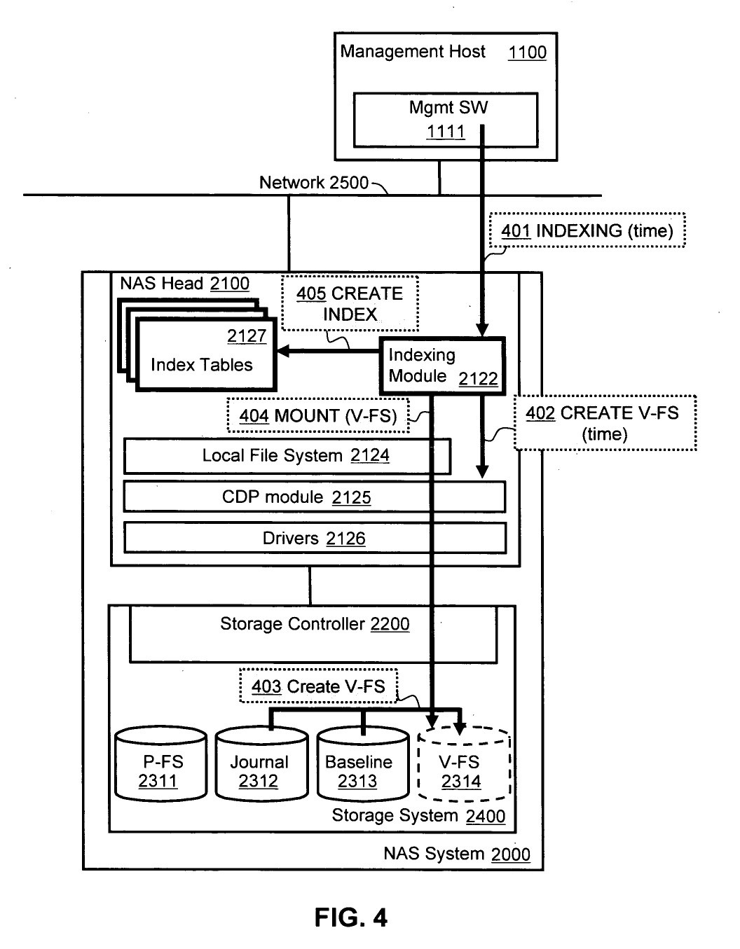

FIG. 4 represents a conceptual diagram of the indexing process when the administrator requests creating index tables at some point in time.

At Step 401, the administrator requests creating index tables 2127 at some point in time to the indexing module 2122 through the management software 1111. The point in time can be any time before the request or at the time of request.

At Step 402, indexing module 2122 requests the creation of a virtual file system 2314 at the specified point in time by the CDP module 2125.

At Step 403, the CDP module creates the virtual file system volume 2314 by applying the journal data 2312 until the designated time to the baseline copy 2313.

At Step 404, after creation of the virtual file system volume 2314 is completed, the indexing module mounts the virtual file system volume 2314.

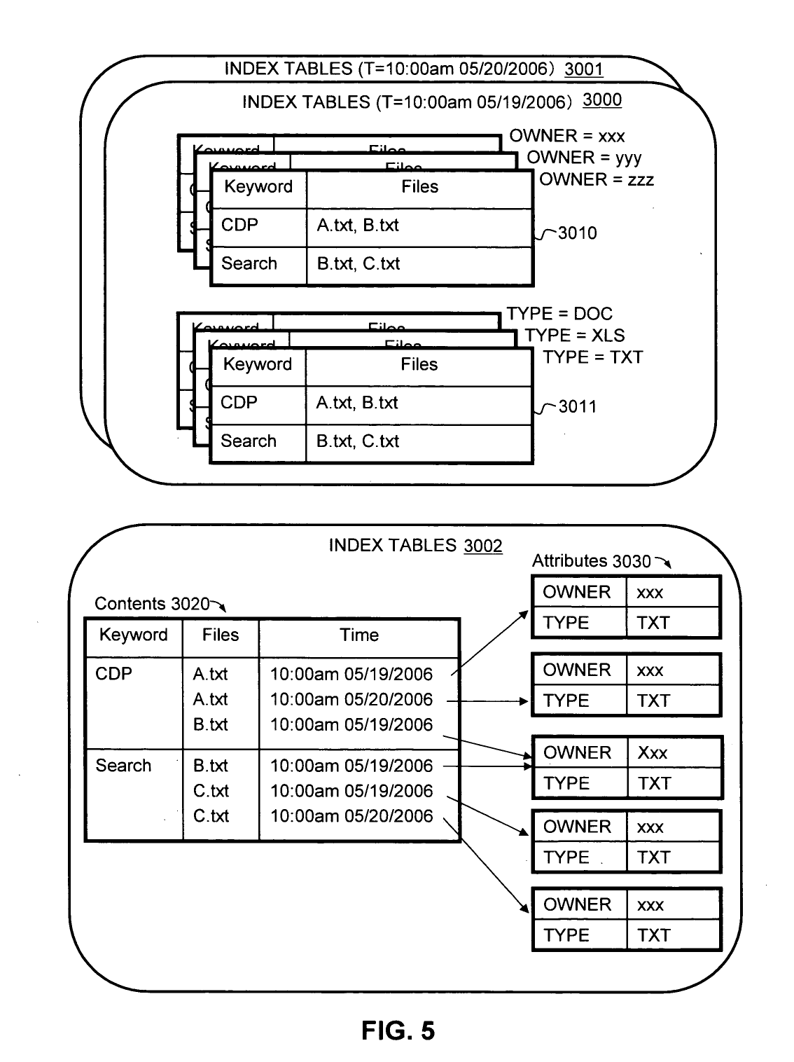

At Step 405, the indexing module creates index tables, such as those illustrated in FIG. 5, based upon the content and/or metadata of the virtual file system volume 2314.

The data structure of the index tables is varied and not intended to limit the invention. The index tables can be created not only from data content, but also from metadata such as inode information. FIG. 5 represents examples of index tables 3000, 3001, 3002. A first embodiment includes index tables 3000, 3001 created for specified points in time, such as daily at 10:00 am. As illustrated in index tables 3000, there can be many owner index tables 3010 created according to each file owner. File-type index tables 3011 may also be created according to each file type, such as “doc”, “xls”, “txt”, “pdf”, etc. In another example, a single index table 3002 may be created including the time information for each content. In table 3002, there can be many index tables created by file contents 3020 with time information, and file attributes 3030 associated with the file name. Attributes 3030 can be used to indicate owner, file type, or other attributes of the data stored in primary volume 2311. Thus, the particular structure of the index table does not restrict the invention, and index tables can be created from any combination of the above examples, or other formats that will be apparent to those of skill in the art.

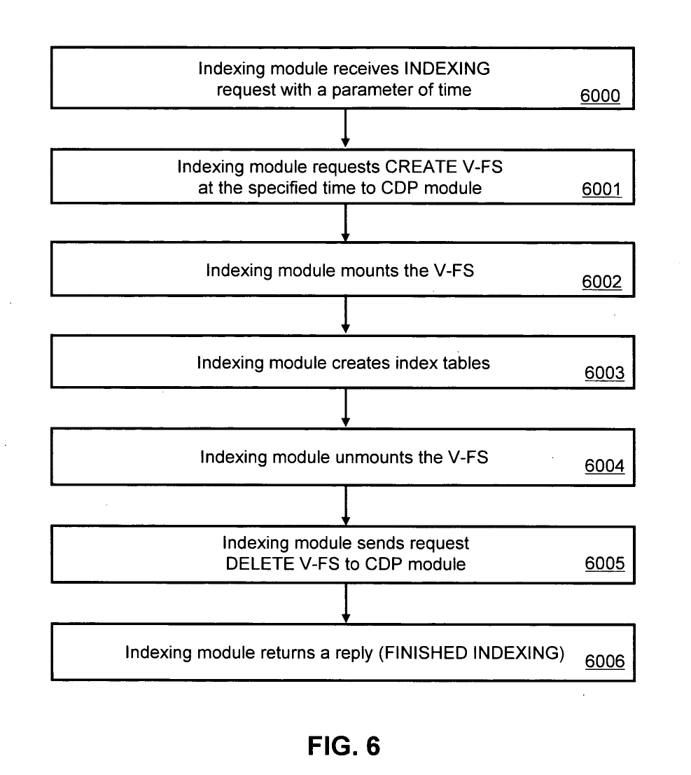

FIG. 6 illustrates a control flow carried out by the indexing module 2122. An administrator or user requests creation of index tables 2127 at some point in time to the indexing module 2122 though the management software 1111. The time can be any time before the request or at the time of request.

At Step 6000, the indexing module receives the index creation request from the administrator.

At Step 6001, the indexing module issues a request for creating a virtual file system at the specified time to the CDP module 2125. The CDP module creates the virtual file system volume 2314 by applying the entries in the journal volume 2312 to the baseline volume 2313 up to the specified time.

At Step 6002, after creation of the virtual file system volume 2314 is completed, the indexing module mounts the virtual file system volume 2314.

At Step 6003, the indexing module creates index tables such as FIG. 5 from the mounted virtual file system volume 2314. The index tables can be created not only from content of the data, but also from metadata such as inode information. Accordingly, the indexing program crawls through the mounted virtual file system and indexes file content and metadata to create an index of the virtual file system as it exists at the specified point in time that the virtual file system volume 2314 is created to in Step 6001. The indexing mechanism may be like those used in search engines discussed above, but the invention is not limited to a particular indexing type.

At Step 6004, after finishing creation of the new index tables, the indexing module 2122 unmounts the virtual file system in order to conserve the system resources.

At Step 6005, the indexing module requests the deletion of the virtual file system to the CDP module to conserve system resources. This step can be made optional. If the administrator does not care about the conservation of systems resources, then this step can be skipped, and go to step 6006.

At Step 6006, after deletion of the virtual file system is completed, the indexing module returns a reply to the management software.

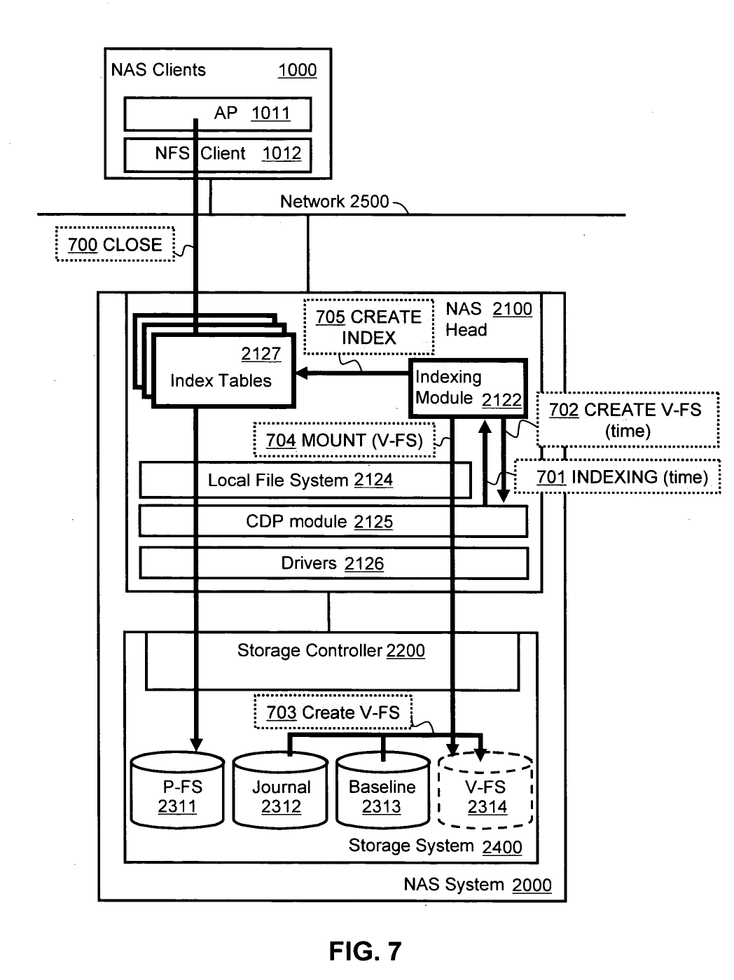

As discussed above, it is also possible to have the indexing process invoked as a result of a triggering event, rather than as a result of a specific request from the administrator or a user. FIG. 7 represents a conceptual diagram of the indexing process invoked at a predetermined event, such as when a file close operation occurs.

At Step 700, application 1011 on NAS client 1000 conducts a triggering operation, such as a close file operation, a write operation, or the like. When this occurs, the CDP module 2125 or local file system 2124 can be programmed to automatically initiate indexing so that a user or operator does not have to be concerned with invoking the module at particular points in time, or the like.

At Step 701, when application 1011 conducts close file operation, this serves as a triggering event that causes CDP module 2125 or local file system 2124 to take notice of the operation, and invokes the indexing module 2122 to create index tables at that point in time. Steps 702-705 are the same as Steps 402-405 described above with respect to FIG. 4, and do not need to be repeated here.

Search and Recovery Process

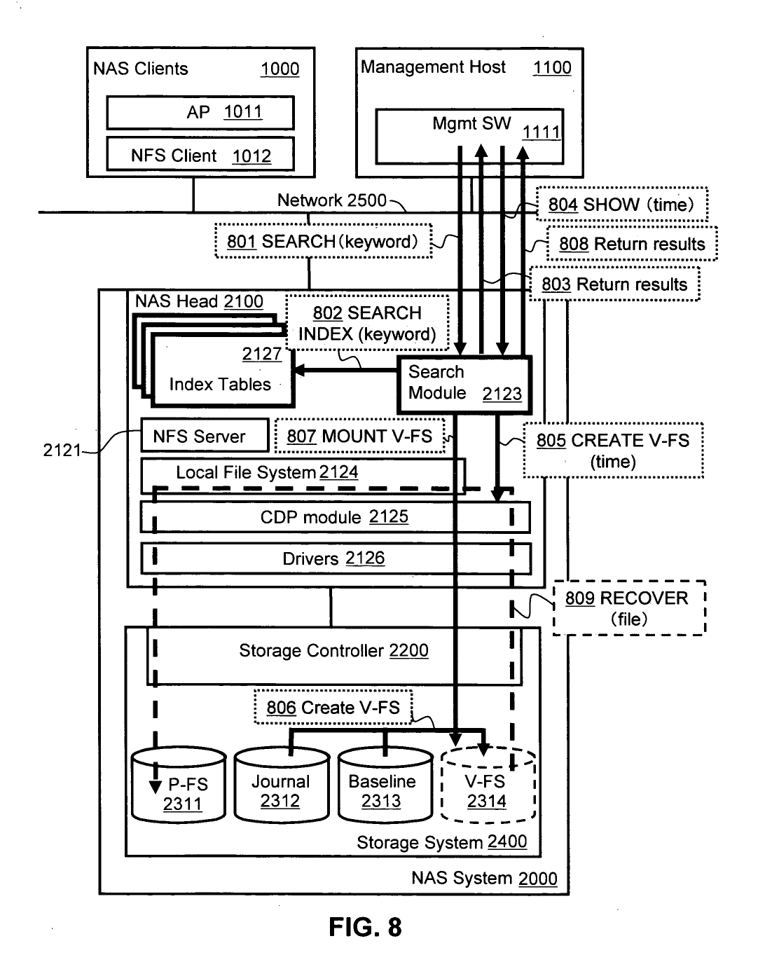

Search module 2123 is a module that is able to track the history of file modifications by searching the index tables 2127 created by the indexing module, and thereby enables easier recovery of data at a desired point in the file history. Search module 2123 includes a searching feature, and also includes a graphic user interface (GUI), as will be described in greater detail below with respect to FIGS. 9-1 to 9-4. FIG. 8 represents a conceptual diagram of one embodiment of the search and recovery process. The recovery process may be carried out following the search process, although other uses may also be made of the search data, so accordingly, the invention is not limited to just recovery of data. In particular, from the search process point of view, it is not necessary to recover data. Just searching for a file can result in useful information. However, from the CDP point of view, a recovery process is important. Thus FIG. 8 illustrates not only the search process but also the recovery process.

At Step 801, an administrator inputs a search query keyword to the search module 2123 through the management software 1111. The keyword might be a file name, file content or metadata information relating to a file or other data that the administrator is trying to recover or otherwise locate information for.

At Step 802, after receiving the keyword, the search module 2123 searches for the keyword in all index tables created by the indexing module 2127. At that time, an index for the current primary file system 2311 can be created also, and the keyword search can be applied to that newly created index for the current data as well.

At Step 803, after finding the instances of the keyword, the search module 2123 returns the search results to the management software 1111.

At Step 804, the administrator is then able to pick out some of the file names and times presented in the search results, and request that the search module 2123 show the contents of the files, such as at a specified time.

At Step 805, the search module 2123 sends a request to the CDP module to create a virtual file system volume 2314 at the designated point in time.

At Step 806, CDP module creates a virtual file system volume 2314 by applying entries in the journal data volume 2312 to the baseline copy volume 2313 up to the specified point in time, as described above.

At Step 807, after finishing creation of the virtual volume 2314, the search module 2123 mounts the virtual file system volume 2314.

At Step 808, the search module 2123 uses the mounted virtual file system volume 2314 to provide the contents of the requested file or files at the specified point in time to the administrator via the GUI.

At Step 809, if the administrator wants to recover the specific instance of the file at the specified point in time, the administrator can send a request to recover the file to the search module 2123, and the search module 2123 reads the instance of the file from the virtual file system volume 2314 and writes the file to the primary file system volume 2311. Since recovery is not a required culmination of the search module results, this step is illustrated with dashed lines.

In another aspect, the administrator is able to use the GUI of the invention to see point-in-time images of files on the virtual file system volume 2314, and is able to see the contents of the files through file system operations without using a special GUI. The administrator can then recover an instance of a file by copying from the virtual file system volume 2314 to the primary file system volume 2311.

FIGS. 9-1A to 9-4 illustrate examples of the GUI of search module 2123. Search module 2123 can be invoked, for example, by management host 1100 through HTTP protocol, and then the GUI can be a Web interface, such as a web page. FIG. 9-1A to 9-1C illustrate three examples 4100, 4200, 4300, respectively, of starting points in which the administrator enters a keyword into a query area 4001. Various keywords or queries can be inputted by the administrator. These include not only words, but also file attributes such as file type, and file names. In the illustrated embodiments, GUI window 4100 illustrates a general word entry of “CDP”, GUI window 4200 illustrates as file type entry of “TXT” and GUI window 4300 illustrates an entry of a file name “a.txt”.

The administrator inputs a search keyword in query area 4001, and clicks on the search button 4003. The process of steps 801-803 described above is then carried out, and the results of the search are displayed in the results area 4002. The results may include not only file names, but their history of modifications because the search module searches all the available index tables. Further, any additional information such as attribute modifications (e.g., file name change, owner change, and so on) can also be displayed in results area 4002. Moreover, predetermined search rankings or weightings can be applied to the results displayed in results area 4002.

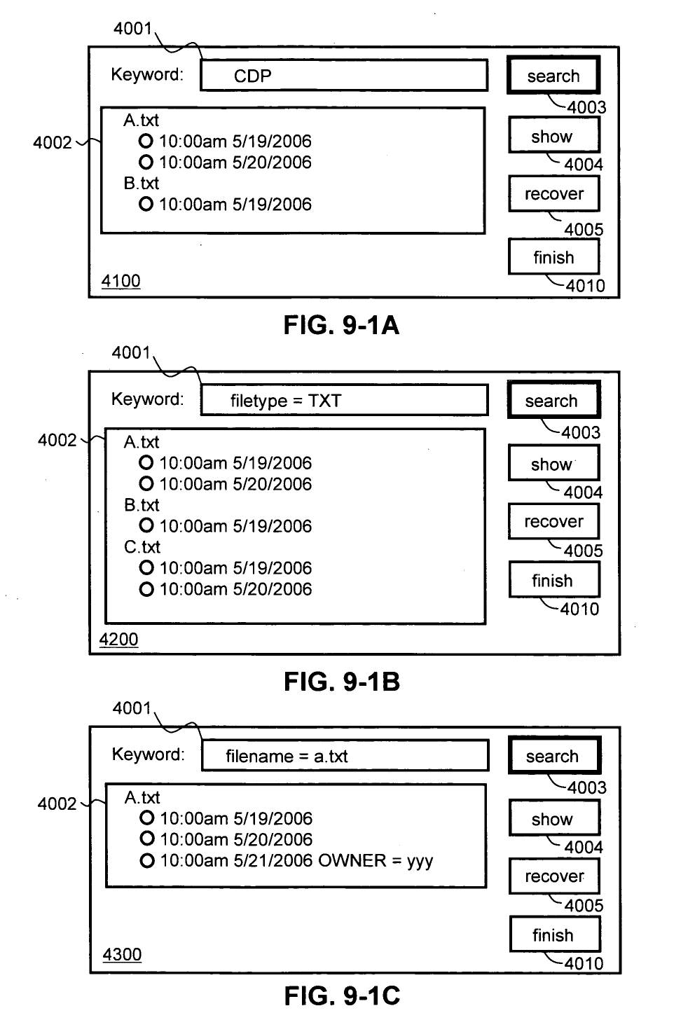

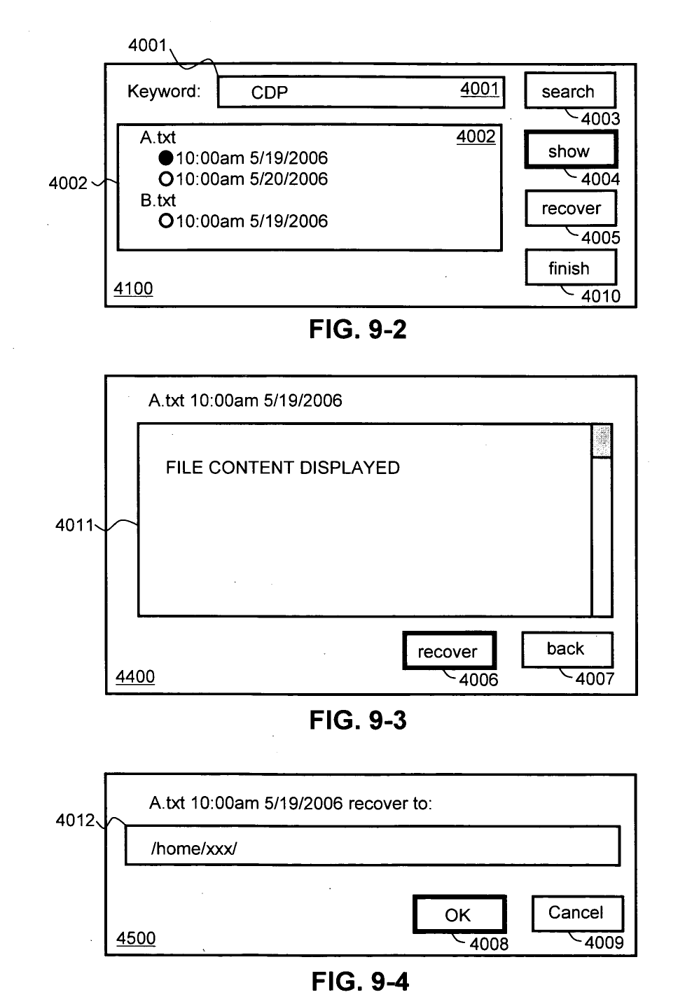

In FIG. 9-2, the administrator is able to pick one or more of file names and times displayed in the results area 4002 by clicking on a selection circle next to the desired selection, or by other means, such as highlighting, clicking on the entry itself, etc. The administrator then clicks on the show button 4004 to request that the search module 2123 display of the contents of the selected file(s). Not only specifying a file name and time, but any other way of specifying the files can be applied (e.g., multiple files and times, range of times, and so on may be used). When the show button 4004 is clicked, the process of Steps 804-808 of FIG. 8 described above is carried out, and the contents of the requested files may be displayed. Alternatively, if the administrator does not need to review the contents of the file, the recover button 4005 may be clicked, and recovery of the selected file will take place. If the administrator does not need to recover a file, or if the administrator is finished viewing the search results, the finish button 4010 may be clicked.

Following selection of the show button 4004, the contents 4011 of a selected file can be displayed in a new GUI display window 4400, as illustrated in FIG. 9-3. Using display window 4400, the administrator is able to review the contents of the selected file, and is able to push the recover button 4006 to request the search module to start recovery of the file, or the back button 4007 may be pushed to view other file contents. FIG. 9-4 illustrate a GUI window 4500 that, following selection of recovering a file, enables the administrator to input a recovery destination in entry area 4012. Then, when the administrator pushes the OK button 4008, the search module reads the file from the virtual file system and writes it to the primary file system volume, as discussed above for Step 809. If the Administrator decides not to recover the file, the cancel button 4009 may be clicked. Further, it will be apparent that various GUI formats can be employed in the invention, and that the particular format or appearance of the GUIs do not restrict the invention. Further, using a GUI is not a critical feature of the invention, and therefore other means may be used for selecting and recovering data, such as use of a command line interface (CLI) for invoking and entering commands to the search module 2123.

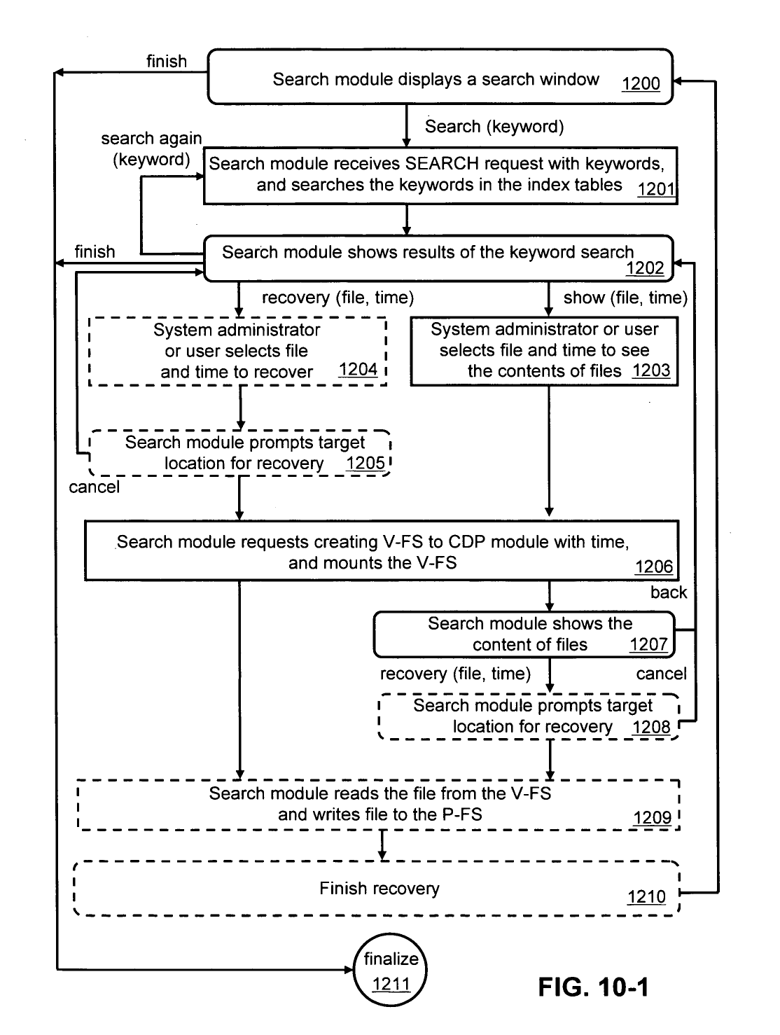

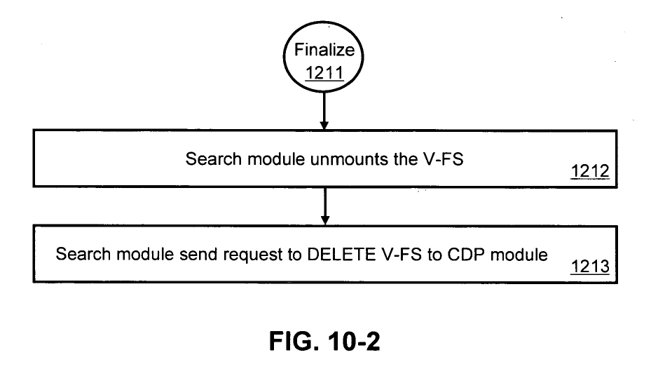

FIG. 10-1 illustrates a control flow of the search module 2123 based on the GUI described above.

At Step 1200, the search module 2123 displays the initial search window such as windows 4100, 4200, 4300. Then, an administrator inputs search keyword and clicks on the search button 4003, as discussed above with reference to FIGS. 9-1A to 9-1C. Alternatively, if the administrator pushes the finish button 4010 in FIGS. 9-1A to 9-1C, the search module proceeds to Step 1211 to perform any steps necessary to finalize the operations, as discussed below.

At Step 1201, after receiving the keyword query, the search module 2123 searches the keyword in all index tables 2127 created by the indexing module 2122. At the same time, an index for the current primary file system volume 2311 can be created also, and the keyword search can be applied to this index as well.

At Step 1202, after finding entries in the index tables containing the keyword, the search module 2123 returns the search result to the management software 1111. If the results of the search are as expected, the administrator proceeds to Step 1203 or 1204. However, if the administrator wants to input another keyword in query area 4001 and the pushes the search button 4003, then the search module goes back to step 1201, and searches the new keyword in the index tables. If the administrator pushes the finish button 4010, then the search module proceeds to Step 1211 to finalize the operations.

At Step 1203, the administrator picks one or more of the file names and times in the search result, and requests the search module 2123 to show the contents of the selected files by clicking the show button 4004, as discussed above with respect to FIG. 9-2.

At Step 1204, alternatively, if the administrator wants to proceed immediately with recovery, the administrator picks one or more file names and times in the search result, and pushes the recover button 4005 in FIG. 9-2. As with FIG. 8, since recovery is not a necessary culmination of the search module results, the steps relating to recovery are illustrated with dashed lines.

At Step 1205, the search module directly goes to the recovery step and prompts the administrator for a target location for recovery, as illustrated in FIG. 9-4, unless the cancel button 4009 is selected.

At Step 1206, the search module requests the CDP module to create a virtual file system volume 2314 at the designated point in time by applying the journal data 2312 to the baseline copy volume 2313 up to the designated point in time, and then mounts the virtual file system volume 2314.

At Step 1207, the search module 2123 provides the contents of the selected file in the GUI so that the administrator may view the contents, as illustrated in FIG. 9-3. Alternatively, if recovery of the selected file is not needed or desired, the back button 4007 may be selected to return to the search results of Step 1202

At Step 1208, when the administrator pushes the recover button 4006 in FIG. 9-3, the search module 2123 prompts the administrator to input the recovery destination as illustrated in FIG. 9-4.

At Step 1209, when the administrator inputs the destination and pushes the OK button 4008, the search module 2123 reads the file from the virtual file system volume 2314 and writes the selected file to the primary file system volume 2311.

At Step 1210, the recovery process is completed, and the search window returns to those such as are illustrated in FIG. 9-1A to 9-1C.

As indicated above, if the administrator picks some of file names and times in the search result (Step 1202), and pushes the recover button (4005 in FIG. 9-2) without first reviewing the content of the file (Step 1204), the search module 2123 directly goes to the recover step (Step 1205). The search module prompts input of the recovery destination (Step 1205). When the administrator inputs the destination and pushes the OK button 4008, the search module requests CDP module 2125 to create a virtual file system volume 2314 at the designated point in time, and mounts the virtual file system (Step 1206). Then, search module 2123 reads the instance of the file from the virtual file system volume 2314 and writes it to the primary file system volume 2311 (Step 1209). And then, the recovery process is complete (Step 1210), and the search window such as FIG. 9-1 is shown.

FIG. 10-2 illustrates a control flow for finalizing operations of search module 2123.

At Step 1212, to finalize the operations, the search module 2123 unmounts all virtual file systems which were mounted during the operations in order to conserve the computational resources.

At Step 1213, the search module sends a request to delete the virtual file system volume 2314 to the CDP module (1213).

As stated above, the invention is not limited to any particular hardware configuration. Thus, in other hardware embodiments, the journal volume 2312 and/or the baseline volume 2313 can be located in a separate storage system or NAS appliance in communication with storage controller 2200 via network 2500 or another network such as a storage area network. Further, in a purely block-based system, NAS head 2100 may be eliminated, the client host 1000 may possess the local file system 2124 and drivers 2126, and management computer 1100 may possess the indexing module 2122, the search module 2123, and the index tables 2127. Still alternatively, NAS head 2100 may instead be a NAS appliance separated from storage system 2400 by a storage area network, or the like, where the NAS appliance acts as a NAS gateway device. Other hardware embodiments will also be apparent to those skilled in the art given the disclosure of the invention.

From the indexing and search system point of view, to create modification histories of each file, the indexing module crawls through data, creates index tables, and stores whole data at some specified time. From the CDP point of view, it is not easy to find an appropriate recovery point, because CDP continuously copies I/O operations into a journal, and there can be a large number of operations in the journal. The indexing and search system acts as a track record search system, and employs CDP technology to provide a method for creating index tables at any point in time, and for searching data at any point in time by using the index tables. In addition, a method is provided for CDP technology to find an appropriate recovery point more easily.

Thus, the disclosure includes a method for creating index tables of journaled data at any point in time, and for searching data at any point in time by using the index tables. It may be seen that the invention provides a useful means for searching for instances and generations of files, and for more easily recovering files to a desired point in time when located. Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of searching and retrieving data, comprising:
providing a first volume in a storage system, said first volume being accessed by a first computer able to store write data to said first volume;
providing a second volume for storing an initial copy of said first volume at a first point in time;
providing a journal volume for storing as journal entries the write data written to said first volume after said first point in time;
creating an index information of the data stored to said first volume at one or more second points in time after said first point in time, said index information including data information on content and attributes of the data stored in said first volume at said one or more second points in time;
searching, after said one or more second points in time, for a first data stored to said first volume at said one or more second points in time, by searching said index information; and
retrieving said first data from a first virtual volume created by applying entries in said journal volume to said second volume up to a specified second point in time.

2. A method according to claim 1, further including steps of
creating said index information at said one or more second points in time by applying entries in said journal volume to said second volume to create a second virtual volume; and
indexing the data information from said second virtual volume to create said index information.

3. A method according to claim 2, further including a step of
indexing the data information from said second virtual volume by searching said second virtual volume for content or file attributes including file names, file types, or file owners, and storing an indication of where said content or attributes are located.

4. A method according to claim 1, further including a step of
creating said index information at said one or more second points in time in response to a triggering event, wherein said triggering event is closing of a file at said computer.

5. A method according to claim 1, further including a step of
recovering, after said searching, a first file restored to said first volume said first file containing an instance of the first file at said second point in time.

6. A method according to claim 1, further including a step of
including a graphic user interface (GUI) for displaying results of said searching, said results including one or more names of files located by said searching and one or more times of modification said one or more files.

7. A method according to claim 6, further including steps of
providing a management computer in communication with said storage system, said management computer displaying said GUI to an administrator, whereby said administrator requests said searching and said retrieving via said GUI.

8. A method according to claim 1, further including steps of
providing said journal volume and/or said second volume in a second storage system separate from said storage system storing said first volume.

9. A method for storing and retrieving data, said method comprising:
providing a storage system including a controller and disk drives, said storage system including a first volume allocated storage space on said disk drives for storing write data received from a first computer;
providing a second volume, said second volume storing a copy of data stored on said first volume at a first point in time;
providing a continuous data protection (CDP) module operative for storing a copy of each write data received by said first volume as a journal entry in a journal volume; and
indexing the data stored in said first volume at one or more second points in time after said first point in time by invoking said CDP module to create a virtual volume corresponding to each said one or second points in time, and indexing information contained in each said virtual volume to create index information.

10. A method according to claim 9, further including steps of
creating said index information at said one or more second points in time, in response to a triggering event, wherein said triggering event is closing of a file at said computer.

11. A method according to claim 9, further including steps of
searching said index information to locate an instance of a first file based upon an input query, wherein the instance of the first file at a specified second point in time is located; and
retrieving information on said instance of the first file by invoking said CDP module to apply said journal volume to said second volume up to said specified second point in time.

12. A method according to claim 11, further including steps of
recovering, said instance of said first file to said first volume by directing said CDP module to copy said instance of said first file to said first volume.

13. A method according to claim 9, further including steps of
providing a graphic user interface (GUI) for displaying results of said searching, said results including names of one or more files located by said searching and one or more times of modification corresponding to said one or more files.

14. A method according to claim 9, further including a step of
providing said journal volume and/or said second volume in a second storage system separate from said storage system including said first volume.

15. A system for indexing and searching, comprising:
a first storage system having a first volume for storing data received from a first computer;
a second volume storing a copy of said first volume at a first point in time;
a journal volume storing write data written to said first volume after said first point in time;
a continuous data protection (CDP) module for copying write data written by said first computer to said first volume to said journal volume, said CDP module being programmed to create a virtual volume reflecting a condition of data stored in said first volume at a specified point in time after said first point in time by applying entries in said journal volume to said second volume up to said specified point in time;
an indexing module configured for collecting information of the data stored in said first volume and creating index tables of data collected at one or more second points in time, said indexing module being programmed to create said one or more index tables by invoking said CDP module to create said virtual volume; and
a search module able to be invoked after said one or more second points in time to search said index tables in response to a query to enable retrieval of file information in existence during at least one of said one or more second points in time.

16. The system according to claim 15, wherein
said search module is further programmed to provide a graphic user interface to enable display of results of said search.

17. The system according to claim 15, wherein
said search module is further programmed to be able to invoke said CDP module to recover an instance of a file at one of said second points in time to said first volume.

18. The system according to claim 15, wherein
said journal volume and/or said second volume are located in a second storage system separate from the first storage system having said first volume.

19. The system according to claim 15, wherein
said index tables include at least one of file type information, file owner information, or file name information.

20. The system according to claim 15, wherein
said indexing module is configured to create said index tables in response to a triggering event, wherein said triggering event is closing of a file at said first computer.
